(19) United States
(12) Patent Application Publication
(10) Pub. No.: US 2024/0089779 A1
(43) Pub. Date: Mar. 14, 2024

(54) PROCESSING TERMINAL DEVICE SENSING DATA USING A NETWORK FUNCTION ELEMENT

(71) Applicant: Tencent Technology (Shenzhen) Company Limited, Shenzhen (CN)

(72) Inventor: Zhuoyun ZHANG, Shenzhen (CN)

(73) Assignee: Tencent Technology (Shenzhen) Company Limited, Shenzhen (CN)

(21) Appl. No.: 18/516,542

(22) Filed: Nov. 21, 2023

Related U.S. Application Data
(63) Continuation of application No. PCT/CN2022/136797, filed on Dec. 6, 2022.

(30) Foreign Application Priority Data
Mar. 3, 2022 (CN) 202210203727.4

(51) Int. Cl. H04W 24/10; H04W 4/38

(52) U.S. Cl. CPC H04W 24/10; H04W 4/38

(57) ABSTRACT

A method for obtaining sensing data includes transmitting, by a network function element to a terminal device, sensing data request information comprising parameters for sensing and reporting data by the terminal device. The sensing data request information indicates, to the terminal device, to report sensing data to the network function element according to the parameters. The method further includes obtaining sensing data returned by the terminal device, the sensing data being transmitted by the terminal device according to the parameters indicated in the sensing data request information. The method further includes preprocessing, by the network function element, the sensing data and providing a result of the preprocessing to a server.

### RELATED APPLICATIONS

This application is a continuation of International Application No. PCT/CN2022/136797, filed on Dec. 6, 2022, which claims priority to Chinese Patent Application No. 202210203727.4 filed on Mar. 3, 2022. The entire disclosures of the prior applications are hereby incorporated by reference in their entirety.

### FIELD OF THE TECHNOLOGY

This application relates to the field of communications technologies, including a method and an apparatus for obtaining sensing data, a method and an apparatus for reporting sensing data, a device, a storage medium, and a program product.

### BACKGROUND OF THE DISCLOSURE

With the development of terminal technologies, a terminal device may communicate with a network based on conventional communications technologies, and may sense information about the terminal device and a surrounding environment. However, in the related art, for schemes of reporting sensing data of a terminal, an application layer reporting scheme is usually used. That is, sensing data is directly transparently transmitted to a service server. As a result, a mobile network cannot collaboratively process and utilize sensing data.

### SUMMARY

Embodiments of this disclosure provide a method and an apparatus for obtaining sensing data, a method and an apparatus for reporting sensing data, a device, a storage medium, and a program product. In this way, a mobile network can obtain sensing data, to facilitate collaborative processing and utilization of sensing data by the mobile network.

In an embodiment, a method for obtaining sensing data includes transmitting, by a network function element to a terminal device, sensing data request information comprising parameters for sensing and reporting data by the terminal device. The sensing data request information indicates, to the terminal device, to report sensing data to the network function element according to the parameters. The method further includes obtaining sensing data returned by the terminal device, the sensing data being transmitted by the terminal device according to the parameters indicated in the sensing data request information. The method further includes preprocessing, by the network function element, the sensing data and providing a result of the preprocessing to a server.

In an embodiment, an apparatus for obtaining sensing data includes processing circuitry of a network function element configured to transmit, to a terminal device, sensing data request information comprising parameters for sensing and reporting data by the terminal device. The sensing data request information indicates, to the terminal device, to report sensing data to the network function element according to the parameters. The processing circuitry is further configured to obtain sensing data returned by the terminal device, the sensing data being transmitted by the terminal device according to the parameters. The processing circuitry is further configured to preprocess the sensing data and provide a result of the preprocessing to a server.

In an embodiment, a non-transitory computer-readable storage medium stores computer-readable instructions thereon, which, when executed by processing circuitry of a network function element, cause the network function element to perform a method of obtaining sensing data. The method includes transmitting, by the network function element to a terminal device, sensing data request information comprising parameters for sensing and reporting data by the terminal device. The sensing data request information indicates, to the terminal device, to report sensing data to the network function element according to the parameters. The method further includes obtaining sensing data returned by the terminal device, the sensing data being transmitted by the terminal device according to the parameters indicated in the sensing data request information. The method further includes preprocessing, by the network function element, the sensing data and providing a result of the preprocessing to a server.

In the embodiments of this disclosure, sensing data request information is sent to a terminal device, where the sensing data request information includes sensing data reporting information, and the sensing data request information is used for indicating the terminal device to report sensing data according to the sensing data reporting information. Then feedback information returned by the terminal device is obtained, where the feedback information is sent by the terminal device according to the sensing data reporting information. Next, sensing data is obtained according to the feedback information. In this way, a mobile network can be enabled to sense related data of the terminal device, so that the mobile network is enabled to collaborate with a service server to process and utilize sensing data. Compared with schemes of processing data purely based on a service server in the related art, processing pressure on a back-end service server is reduced, so that efficiency of processing data is improved.

### BRIEF DESCRIPTION OF THE DRAWINGS

FIG. 1 is a schematic structural diagram of a system for obtaining sensing data according to an embodiment of this disclosure.

FIG. 2 is a schematic flowchart of a method for obtaining sensing data according to an embodiment of this disclosure.

FIG. 3 is a schematic diagram of an application scenario of a method for obtaining sensing data according to an embodiment of this disclosure.

FIG. 4 is a schematic flowchart of a method for reporting sensing data according to an embodiment of this disclosure.

FIG. 5 is a schematic block diagram of an apparatus for obtaining sensing data according to an embodiment of this disclosure.

FIG. 6 is a schematic block diagram of an apparatus for reporting sensing data according to an embodiment of this disclosure.

FIG. 7 is a schematic block diagram of a network device according to an embodiment of this disclosure.

### DESCRIPTION OF EMBODIMENTS

Technical solutions in embodiments of this disclosure are described below with reference to the accompanying drawings in the embodiments of this disclosure.

The embodiments of this disclosure provide a method and an apparatus for obtaining sensing data and a method and an apparatus for reporting sensing data. The embodiments of this disclosure may be applied to various scenarios such as 5G, cloud technology, and smart transportation.

First, some nouns or terms that appear during descriptions of the embodiments of this disclosure are explained as follows:

5^{th} generation mobile communication technology (5G) is a new generation broadband mobile communication technology with characteristics of a high speed, low latency, and massive connections, and is a network infrastructure that implements the interconnection of man-machine-things.

An objective of the 3rd generation partnership project (3GPP) is to implement a smooth transition from 2G networks to 3G networks, to ensure backward compatibility of future technologies, and support easy network construction and roaming and compatibility between systems.

A user equipment (UE) route selection policy (URSP) rule is defined in the 3GPP 5G protocol. The URSP rule includes two sets of important parameters. One set is a traffic descriptor parameter, including a data network name (DNN), an IP 3-tuple (IP descriptor), a domain descriptor, connection capabilities, and other parameters. The other set is a route selection descriptor, including single network slice selection assistance information (S-NSSAI), a session and service continuity (SSC) mode, a DNN, and other parameters. The URSP rule is a correspondence between multiple sets of traffic descriptors and route selection descriptors.

A policy control function (PCF) is a 5G core network element and provides functions such as access selection for user terminals that the PCF is responsible for and PDU session related policies.

A protocol data unit (PDU) session is a data plane channel for communication between UE and a data network (DN). After the PDU session is established, a data transmission channel between the UE and the DN is established.

A user plane function (UPF) is a user plane functional entity, and has a main function of being responsible for routing and forwarding of data packets and QoS flow mapping.

An access and mobility management function (AMF) is an access and mobility management functional entity.

A session management function (SMF) is a session management functional entity.

A unified data manager (UDM) is responsible for generating authentication vectors and is used as a front end for user data and authentication data.

Encapsulation: To implement transmission through a network, data needs to be transmitted layer by layer from an upper layer. If a host wants to transmit data to another host, the data needs to be first packaged into a data packet of a special protocol at a sending end, and header information is added layer by layer. This process is called encapsulation.

Decapsulation: When the data is transmitted to a receiving device, the receiving device needs to delete added information, and decides, according to a header, to transfer the data up along a protocol stack to an appropriate application. This process is called decapsulation.

Smart transportation makes full use of new generation information technologies such as internet of things, space sensing, cloud computing, and mobile internet in the entire transportation field, and comprehensively uses theories and tools such as transportation science, systematic methods, artificial intelligence, and knowledge mining. With the objectives of comprehensive sensing, deep integration, active service, and scientific decision-making, smart transportation builds a real-time dynamic information service system, deeply mines transportation-related data, forms a problem analysis model, and implements improvement of industry resource allocation optimization capability, public decision-making capability, industry management capability, and public service capability, thereby promoting safer, more efficient, more convenient, more economical, more environmentally friendly, and more comfortable operation and development of transportation, and driving transformation and upgrading of transportation-related industries.

The cloud technology is a hosting technology that unifies a series of resources such as hardware, software, and networks in a wide area network or a local area network to implement computing, storage, processing, and sharing of data. The cloud technology is a collective name of a network technology, an information technology, an integration technology, a management platform technology, an application technology, and the like based on an application of a cloud computing business mode, and may form a resource pool, which is used as required, and is flexible and convenient. The cloud computing technology becomes an important support. A background service of a technical network system requires a large amount of computing and storage resources, such as video websites, image websites, and more portal websites. As the Internet industry is highly developed and applied, each article may have its own identifier in the future and needs to be transmitted to a background system for logical processing. Data at different levels is separately processed, and data in various industries requires strong system support, which can only be implemented through cloud computing.

A blockchain system may be a distributed system formed by connecting clients and a plurality of nodes (computing devices in any form, for example, a server and a user terminal, connected to a network) through network communication. A peer to peer (P2P) network is formed between the nodes. A P2P protocol is an application layer protocol that runs on top of a transmission control protocol (TCP). In a distributed system, any machine such as a server or a terminal may join to become a node. The node includes a hardware layer, a middle layer, an operating system layer, and an application layer.

The embodiments of this disclosure may be implemented in combination with the cloud technology or the blockchain technology. In the method for obtaining sensing data disclosed in the embodiments of this disclosure, such data may be stored on a blockchain.

For example, sensing capability indication information, sensing data request information, feedback information, a first data packet, a second data packet, and an encrypted data packet may all be stored on the blockchain. To facilitate storage and query of the sensing capability indication information, the sensing data request information, the feedback information, the first data packet, the second data packet, and the encrypted data packet, in some embodiments, the method for obtaining sensing data further includes: sending the sensing capability indication information, the sensing data request information, the feedback information, the first data packet, the second data packet, and the encrypted data packet to a blockchain network, so that nodes of the blockchain network fill the sensing capability indication information, the sensing data request information, the feedback information, the first data packet, the second data packet, and the encrypted data packet into a new block, and add the new block to an end of the blockchain when reaching a consensus on the new block. In the embodiments of this disclosure, the sensing capability indication information, the sensing data request information, the feedback information, the first data packet, the second data packet, and the encrypted data packet may be stored on a chain to implement backup of records.

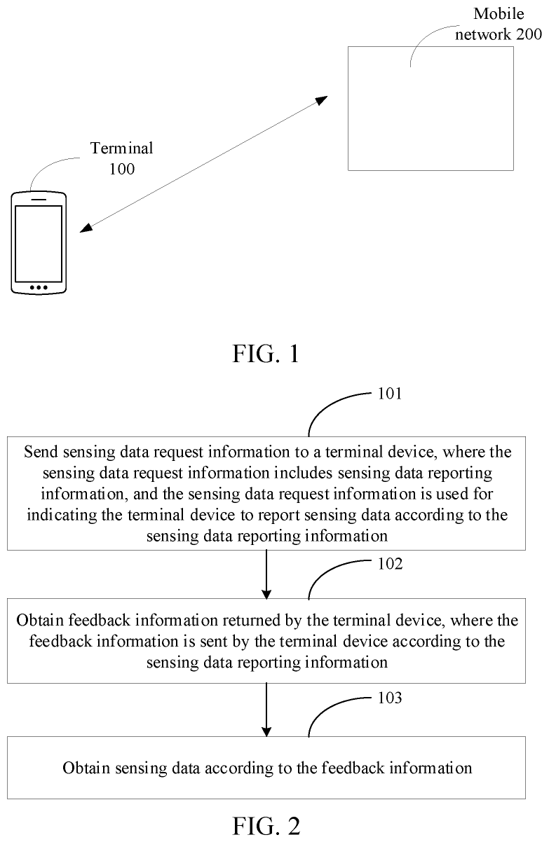

FIG. 1 is a schematic structural diagram of a system for obtaining sensing data according to an embodiment of this disclosure. The system for obtaining sensing data includes a terminal 100 and a mobile network 200.

The terminal 100 may also be referred to as UE, an access terminal, a user unit, a user station, a mobile station, a mobile platform, a remote station, a remote terminal, a mobile device, a user terminal, a terminal, a wireless communication device, a user agent, a user apparatus, or the like. The terminal is a device such as a smartphone, a tablet personal computer, a laptop computer, a personal digital assistant (PDA), a mobile internet device (MID), a wearable device, or an in-vehicle device. The mobile network 200 may include a core network (CN) and a radio access network (RAN). The mobile network 200 may include a functional network element configured to obtain sensing data. According to the embodiments of this disclosure, the CN may include a CN device, a CN network function, a CN network element, for example, a mobility management entity (MME), an AMF, an SMF, a UPF, and a PCF. Different generations of mobile communication CNs include different network elements or network functions.

According to the embodiments of this disclosure, the RAN may include a RAN device, a RAN node, a non-3GPP RAN, a central unit (CU), a distributed unit (DU), a base station, an evolved Node B (eNB), a 5G Node B (gNB), a radio network controller (RNC), a NodeB, a non-3GPP interworking function (N3IWF), an access controller (AC) node, an access point (AP) device, or a wireless local area network (WLAN) node.

According to the embodiments of this disclosure, when obtaining sensing data, the terminal 100 may be specifically configured to: obtain sensing data request information sent by a network device, where the sensing data request information includes sensing data reporting information; determine target sensing data according to the sensing data reporting information, and generate feedback information according to the target sensing data, where the target sensing data is sensing data corresponding to the sensing data reporting information; and return the feedback information to the network device.

According to the embodiments of this disclosure, when obtaining sensing data, the mobile network 200 may be specifically configured to: send sensing data request information to a terminal device, where the sensing data request information includes sensing data reporting information, and the sensing data request information is used for indicating the terminal device to report sensing data according to the sensing data reporting information; obtain feedback information returned by the terminal device, where the feedback information is information obtained by the terminal device by performing information feedback according to the sensing data reporting information; and obtain sensing data according to the feedback information.

Detailed descriptions are separately provided below. A description order of the following embodiments is not construed as a limitation on a preferred order of the embodiments.

FIG. 2 is a schematic flowchart of a method for obtaining sensing data according to an embodiment of this disclosure. For example, the method may be applied to a network device such as a base station or a network element. The method mainly includes step 101 to step 103, described as follows:

Step 101: Send sensing data request information to a terminal device, where the sensing data request information includes sensing data reporting information, and the sensing data request information is used for indicating the terminal device to report sensing data according to the sensing data reporting information. For example, sensing data request information comprising parameters for sensing and reporting data by the terminal device is transmitted by a network function element to the terminal device. The sensing data request information indicates, to the terminal device, to report sensing data to the network function element according to the parameters.

The sensing data request information is used for requesting the terminal device to report sensing data. The sensing data request information includes the sensing data reporting information. The sensing data reporting information may be at least one of the following information: a sensing data type, reporting frequency of sensing data, a maximum reporting quantity, a reporting start time, a reporting end time, a reporting start condition, and a reporting end condition. The sensing data request information is used for indicating the terminal device to report sensing data according to the sensing data reporting information. For example, in a case that the sensing data reporting information includes the sensing data type and the reporting frequency of sensing data, the terminal device may acquire corresponding sensing data according to the sensing data type, and then may report the sensing data to the network device according to the reporting frequency of sensing data.

For example, the reporting start condition may be at least one of the following: the terminal device performs reporting when a speed is greater than 50 km/h; the terminal device starts to report data when humidity, a temperature, and a wind speed are greater than critical values; and the terminal device starts to report data when environmental event information is detected. For example, the reporting frequency may be once an hour, that is, the terminal device reports sensing data to a mobile network once an hour according to the reporting frequency.

For example, a specific control plane network element for collecting sensing data may be deployed in the mobile network to collect information about sensing data. According to the embodiments of this disclosure, a service control function (SCF) is used to refer to the control plane network element, that is, the network device, that supports obtaining of sensing data.

For example, the method may further include: obtaining sensing capability indication information sent by the terminal device, where the sensing capability indication information is used for indicating whether the terminal device supports reporting of sensing data; and generating the sensing data request information and sending the sensing data request information to the terminal device if the sensing capability indication information indicates that the terminal device supports reporting of sensing data.

It can be understood that the terminal device may determine, according to sensing capability of the terminal device, whether to support reporting of sensing data. For example, if a sensing apparatus capable of acquiring sensing data is installed on the terminal device, it is determined that reporting of sensing data is supported. If a sensing apparatus capable of acquiring sensing data is not installed on the terminal device, it is determined that reporting of sensing data is not supported. Then, the sensing capability indication information is generated according to whether reporting of sensing data is supported, and the sensing capability indication information is sent to the network device.

For example, it is defined that sensing capability identification information indicates whether the terminal device supports reporting of sensing data. For example, the sensing capability identification information may indicate “support” or “not support”. If the sensing capability identification information received by the mobile network indicates “support”, it is considered that the corresponding terminal device supports reporting of sensing data. If the sensing capability identification information received by the mobile network indicates “not support”, it is considered that the corresponding terminal device does not support reporting of sensing data. In another example, identification information indicating that reporting of sensing data is supported may be defined. If the mobile network receives the identification information, it indicates that the corresponding terminal device supports reporting of sensing data, or otherwise, it indicates that the corresponding terminal device does not support reporting of sensing data.

For example, the sensing capability indication information sent by the terminal device may be used for indicating a specific sensing data type that supports reporting, and the network device generates sensing data request information according to the sensing capability indication information. For example, the sensing data request information includes the sensing data reporting information, where the sensing data reporting information includes a specific sensing data type that supports reporting and that is indicated by the sensing capability indication information.

For example, in a case that the sensing capability indication information sent by the terminal device indicates that reporting of location information is supported, the sensing data request information may be used for requesting the terminal device to report location information.

For ease of understanding, the embodiments of this disclosure use a 5G network architecture as an example to describe the method for obtaining sensing data according to the embodiments of this disclosure. In a process of subsequent network evolution, communication networks such as a 6G network and a 7G network may also use the method for obtaining sensing data according to the embodiments of this disclosure.

For example, the “sending sensing data request information to a terminal device” may mainly include: encapsulating the sensing data request information into a first data packet, where the sensing data reporting information includes at least one of the sensing data type, the reporting frequency of sensing data, the maximum reporting quantity of sensing data, the reporting start time of sensing data, the reporting end time of sensing data, and a reporting start and end condition of sensing data; and sending the first data packet to the terminal device.

The “sending the first data packet to the terminal device” may specifically include: encrypting the first data packet, and sending the first data packet to the terminal device.

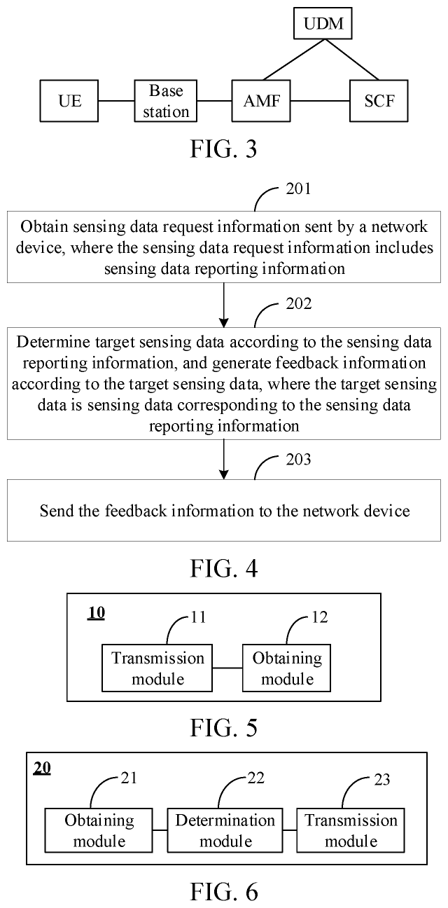

For example, the sensing data request information may be encapsulated in a specific data packet, for example, a sensing request container. Another network functional unit and a base station of the mobile network transparently transmit the data packet. For example, as shown in FIG. 3, the SCF may send the data packet to an AMF serving the UE, the AMF then sends the data packet to a base station serving the UE, and finally the base station sends the data packet to the UE. A transmission path is a possible implementation. Alternatively, the SCF may send the data packet to an SMF serving the UE first, the SMF sends the data packet to the AMF, then the AMF sends the data packet to a base station, and finally the base station sends the data packet to the UE. A specific transmission path is not limited in the embodiments of this disclosure.

Step 102: Obtain feedback information returned by the terminal device, where the feedback information is sent by the terminal device according to the sensing data reporting information. For example, sensing data returned by the terminal device is obtained. The sensing data was transmitted by the terminal device according to the parameters indicated in the sensing data request information.

The feedback information may include the sensing data or the sensing capability indication information. For example, the terminal device receives the sensing data request information sent by the network device, and the terminal device supports reporting of sensing data. The terminal device determines, according to the sensing data reporting information, target sensing data to be reported, performs operations such as encapsulation or encryption on the target sensing data to be reported, generates feedback information, and returns the feedback information to the network device. In another example, the terminal device receives the sensing data request information sent by the network device, and the terminal device does not support reporting of sensing data. The terminal device may generate sensing capability indication information, perform operations such as encapsulation or encryption on the sensing capability indication information, generate feedback information, and return the feedback information to the network device.

Step 103: Obtain sensing data according to the feedback information. For example, the sensing data is preprocessed by the network function element and a result of the preprocessing is provided to a server.

The sensing data may include at least one of the following of the terminal device: location information, speed information, acceleration information, temperature information, humidity information, wind speed information, surrounding event information, and the like.

In some embodiments, 102 may mainly include: obtaining an encrypted data packet returned by the terminal device. Step 103 may include: decrypting the encrypted data packet to obtain a second data packet; decapsulating the second data packet; and obtaining the sensing data according to the decapsulated second data packet.

A type of the second data packet may be consistent with a type of the first data packet or may be inconsistent with the type of the first data packet. To avoid a problem of data leakage caused by malicious interception of sensing data, when transmitting a data packet, the terminal device may encrypt the data packet and transmit the encrypted data packet to the control plane network element.

For example, when obtaining the first data packet, the terminal device determines whether reporting of data of the sensing data type that the sensing data request information requests to report is supported, encapsulates sensing data of a supported type in the second data packet, and leaves sensing data of an unsupported type empty, or encapsulates the second data packet with a value that has no specific meaning. The type of the second data packet may be consistent with the type of the first data packet, for example, is a sensing request container. Then, the terminal device sends the data packet to the base station, and finally the data packet is sent to the SCF through an original path.

In some embodiments, if the sensing data reporting information includes the reporting frequency of sensing data, after sensing data is obtained according to the feedback information for the first time, it is detected, according to a time at which the terminal device first returns the feedback information, whether the terminal device returns the feedback information according to the reporting frequency of sensing data. The sensing data request information is resent to the terminal device if it is detected that the terminal device does not return the feedback information according to the reporting frequency of sensing data.

The reporting frequency of sensing data may be determined according to a type of the terminal device or a type of sensing data, so that the mobile network better grasps a status of sensing data, and better collaboratively processes and utilizes sensing data. Therefore, if the sensing data reporting information includes the reporting frequency of sensing data, in a case that the terminal device does not return sensing data according to the reporting frequency of sensing data, the sensing data request information may be resent to the terminal device to obtain sensing data.

A service server is a server that receives sensing data in a specific service scenario and that executes corresponding service logic (depending on requirements of a specific application scenario, for example, an operation mode of an air conditioner in an environment in which the terminal device is located is controlled according to temperature and humidity data reported by the terminal device, or various nearby services are recommended according to a location reported by the terminal device). The mobile network collaborates with the service server to process sensing data in various manners. Details are described separately below.

In some embodiments, the mobile network may perform some steps of service processing logic on sensing data. For example, the mobile network may perform preprocessing steps on data, including filtering out incomplete data, data whose value is within a specified inappropriate range, and the like, to help reduce processing pressure of the service server and improve efficiency of processing sensing data.

In another embodiment, the mobile network may execute service processing logic on some sensing data (sensing data of various specific types, for example, a specific location, a specific speed, specific acceleration, a specific temperature, specific humidity, and a specific wind speed) reported by the terminal device, and send a processing result to the service server, to reduce processing pressure of the service server.

For example, in a high-load state of the service server (for example, a quantity of concurrent requests of the service server causes CPU usage exceeding a first threshold value, for example, 90%), the mobile network may execute service processing logic on some sensing data reported by the terminal device (sensing data of specific types, for example, a speed, or a temperature), and send a processing result to the service server, to reduce processing pressure of the service server. In a low-load state of the service server (for example, a quantity of concurrent requests of the service server causes CPU usage less than a second threshold value, for example, 30%), the mobile network may execute service processing logic on some sensing data reported by the terminal device (sensing data of specific types, for example, a speed, or a temperature), to make full use of computing resources of the service server.

In some embodiments, the sensing data reporting information may include the sensing data type. The sensing data type includes at least one of location information, speed information, acceleration information, temperature information, humidity information, wind speed information, and surrounding event information of the terminal device. Step 103 may specifically include: obtaining sensing data corresponding to the sensing data type according to the feedback information returned by the terminal device, where the sensing data includes at least one of the location information, the speed information, the acceleration information, the temperature information, the humidity information, the wind speed information, and the surrounding event information.

The sensing data type in the sensing data reporting information may be determined according to a type of the terminal device. For example, if the terminal device is an in-vehicle terminal, for example, the terminal may be a trip computer with a wireless communication function, or wireless UE externally connected to a trip computer, the sensing data type in the sensing data reporting information may be determined as event information.

The “event information” is surrounding event information detected by the terminal device. A sensing device of the in-vehicle terminal may sense road event information, for example, road congestion, road accidents, and wrong-way driving on roads. In this case, the road event information is reported to the mobile network for the mobile network to obtain sensing data, to facilitate collaborative processing and utilization of sensing data by the mobile network.

In an example, the terminal device may be a wearable device. The wearable device may also be called a wearable smart device, which is a general term for wearable devices developed by applying wearable technology to intelligent design of daily wear such as glasses, gloves, watches, clothing and shoes. Alternatively, the terminal device may be a device of an unmanned aerial vehicle. Alternatively, the terminal device may be a roadside device, for example, may be a streetlamp, a signal lamp, or another roadside device with a wireless communication function.

In some embodiments, after “sending sensing data request information to a terminal device”, the method may further include: obtaining response information returned by the terminal device.

For example, the terminal device determines, according to the sensing data request information, whether to report such sensing data. If reporting is supported, the terminal device returns response information of an accept request to the SCF. If reporting is not approved, the terminal device returns response information of a reject request to the SCF. If receiving the accept request from the terminal device, the SCF may monitor a reporting status of sensing data by the terminal device according to the reporting frequency carried in a sensing data request (i.e., the sensing data request information). If receiving the reject request from the terminal device, the SCF does not need to allocate a processor resource to the terminal device to monitor a reporting status of sensing data, and the like, thereby saving the processor resource.

According to the embodiments of this disclosure, the sensing data reporting information includes the reporting frequency of sensing data and the maximum reporting quantity. The method further includes: sending the reporting frequency and the maximum reporting quantity of sensing data to a base station corresponding to the terminal device, so that the base station allocates and schedules resources according to the reporting frequency and the maximum reporting quantity of sensing data.

The base station may be a base transceiver station (BTS) in a GSM or CDMA, or may be a NodeB in WCDMA, or may be an evolved NodeB (eNB or e-NodeB) in LTE or a 5G gNB. This is not limited in the embodiments of this disclosure.

All the foregoing technical solutions may be combined in any way to form different implementations of the embodiments of this disclosure, and details are not described herein again.

According to the embodiments of this disclosure, sensing data request information is sent to a terminal device, where the sensing data request information includes sensing data reporting information, and the sensing data request information is used for indicating the terminal device to report sensing data according to the sensing data reporting information. Then feedback information returned by the terminal device is obtained, where the feedback information is sent by the terminal device according to the sensing data reporting information. Then sensing data is obtained according to the feedback information. In this way, a mobile network can obtain sensing data, to facilitate collaborative processing and utilization of sensing data by the mobile network.

FIG. 4 is a schematic flowchart of a method for reporting sensing data according to an embodiment of this disclosure. For example, the method may be applied to a terminal device. The terminal device may be an electronic device with a communication function, for example, a smartphone, a wearable smart device, or an in-vehicle terminal. The method mainly includes step 201 to step 203, described as follows:

Step 201: Obtain sensing data request information sent by a network device, where the sensing data request information includes sensing data reporting information.

For example, the sensing data request information is used by the network device to request the terminal device to report sensing data, and the sensing data reporting information may be at least one of the following information: a sensing data type, reporting frequency of sensing data, a maximum reporting quantity, a reporting start time, a reporting end time, a reporting start condition, and a reporting end condition. The sensing data request information is used for indicating the terminal device to report sensing data according to the sensing data reporting information. For example, in a case that the sensing data reporting information includes the sensing data type and the reporting frequency of sensing data, the terminal device may acquire corresponding sensing data according to the sensing data type, and then may report the sensing data to the network device according to the reporting frequency of sensing data.

In some embodiments, after step 201, the method may further include: sending response information to the network device.

For example, the terminal device determines, according to the sensing data request information, whether to report sensing data. If reporting is supported, the terminal device returns response information of an accept request to the network device. If reporting is not approved, the terminal device returns response information of a reject request to the network device. In this way, it is easy for the network device to allocate a processor resource. For example, if receiving the accept request from the terminal device, the network device may monitor a reporting status of sensing data by the terminal device according to the reporting frequency carried in a sensing data request. If receiving the reject request from the terminal device, the network device does not need to allocate a processor resource to the terminal device to monitor a reporting status of sensing data, and the like, thereby saving the processor resource.

Step 202: Determine target sensing data according to the sensing data reporting information, and generate feedback information according to the target sensing data, where the target sensing data is sensing data corresponding to the sensing data reporting information.

In some embodiments, the sensing data reporting information may include the sensing data type. Step 202 may mainly include: determining sensing data corresponding to the sensing data type as the target sensing data, where the target sensing data includes at least one of location data, speed data, acceleration data, temperature data, humidity data, wind speed data, and surrounding event data of the terminal device.

The sensing data type may include at least one of location information, speed information, acceleration information, temperature information, humidity information, wind speed information, and surrounding event information of the terminal device. The sensing data type in the sensing data reporting information may be determined according to a type of the terminal device. For example, if the terminal device is an in-vehicle terminal, for example, the terminal may be a trip computer with a wireless communication function, or wireless UE externally connected to a trip computer, the sensing data type in the sensing data reporting information may be determined as event information.

The “event information” is information related to a surrounding event detected by the terminal device. A sensing device of the in-vehicle terminal may sense road event information, for example, road congestion, road accidents, and wrong-way driving on roads. In this case, the road event information is reported to the mobile network for the mobile network to obtain sensing data, to facilitate collaborative processing and utilization of sensing data by the mobile network.

As an example rather than a limitation, the terminal device may be a wearable device. The wearable device may also be called a wearable smart device, which is a general term for wearable devices developed by applying wearable technology to intelligent design of daily wear such as glasses, gloves, watches, clothing and shoes. Alternatively, the terminal device may be a device of an unmanned aerial vehicle. Alternatively, the terminal device may be a roadside device, for example, may be a streetlamp, a signal lamp, or another roadside device with a wireless communication function.

Step 203: Send the feedback information to the network device.

In some embodiments, the method may further include: determining sensing capability indication information according to sensing capability of the terminal device, where the sensing capability indication information is used for indicating whether the terminal device supports reporting of sensing data; and sending the sensing capability indication information to the network device.

The terminal device may determine, according to sensing capability of the terminal device, whether to support reporting of sensing data. For example, if a sensing apparatus capable of acquiring sensing data is installed on the terminal device, it is determined that reporting of sensing data is supported. If a sensing apparatus capable of acquiring sensing data is not installed on the terminal device, it is determined that reporting of sensing data is not supported.

For example, it is defined that sensing capability identification information indicates whether the terminal device supports reporting of sensing data. For example, the sensing capability identification information may indicate “support” or “not support”. If the sensing capability identification information received by the mobile network indicates “support”, it is considered that the corresponding terminal device supports reporting of sensing data. If the sensing capability identification information received by the mobile network indicates “not support”, it is considered that the corresponding terminal device does not support reporting of sensing data. In another example, identification information indicating that reporting of sensing data is supported may be defined. If the mobile network receives the identification information, it indicates that the corresponding terminal device supports reporting of sensing data, or otherwise, it indicates that the corresponding terminal device does not support reporting of sensing data.

For example, the sensing capability indication information sent by the terminal device may be used for indicating a specific sensing data type that supports reporting, and the network device may generate sensing data request information according to the sensing capability indication information. For example, the sensing data request information may include the sensing data reporting information, where the sensing data reporting information includes a specific sensing data type that supports reporting and that is indicated by the sensing capability indication information.

For example, in a case that the sensing capability indication information sent by the terminal device indicates that reporting of location information is supported, the sensing data request information may be used for requesting the terminal device to report location information.

For example, the “sending the sensing capability indication information to the network device” may specifically include: sending the sensing capability indication information to the network device in a network registration procedure of the terminal device; or sending the sensing capability indication information to the network device in a location update procedure of the terminal device; or sending the sensing capability indication information to the network device in a session management procedure of the terminal device.

For example, in a mobile network registration procedure, the terminal device may send the sensing capability indication information to a network device in the mobile network. Alternatively, the sensing capability indication information may be sent to a network device in the mobile network in a location update procedure or in a session management procedure. A network device in the mobile network may determine, according to the sensing capability indication information, whether to send the sensing data request information to the terminal device. In this way, it is not necessary to obtain an additional network resource or send the sensing capability indication information to the mobile network, thereby saving a network resource.

All the foregoing technical solutions may be combined in any way to form an implementation of this disclosure. Details are not described herein again.

According to the embodiments of this disclosure, sensing data request information sent by a network device is obtained, where the sensing data request information includes sensing data reporting information. Then, target sensing data is determined according to the sensing data reporting information, and feedback information is generated according to the target sensing data, where the target sensing data is sensing data corresponding to the sensing data reporting information. Then, the feedback information is sent to the network device, so that the network device obtains sensing data according to the feedback information. In this way, a mobile network obtains sensing data, to facilitate collaborative processing and utilization of sensing data by the mobile network.

The method embodiments of this disclosure are described in detail above, and apparatus embodiments of this disclosure are described in detail below with reference to FIG. 4. It is to be understood that the apparatus embodiments correspond to the method embodiments, and refer to the method embodiments similar descriptions.

FIG. 5 is a schematic structural diagram of an apparatus 10 for obtaining sensing data according to an embodiment of this disclosure. As shown in FIG. 5, the apparatus 10 for obtaining sensing data may include:
a transmission module 11, configured to send sensing data request information to a terminal device, where the sensing data request information includes sensing data reporting information, and the sensing data request information is used for indicating the terminal device to report sensing data according to the sensing data reporting information;
an obtaining module 12, configured to: obtain feedback information returned by the terminal device, the feedback information being sent by the terminal device according to the sensing data reporting information; and obtain sensing data according to the feedback information.

In some embodiments, the transmission module 11 may be configured to: encapsulate the sensing data request information into a first data packet, where the sensing data reporting information includes at least one of a sensing data type, reporting frequency of sensing data, a maximum reporting quantity of sensing data, a reporting start time of sensing data, a reporting end time of sensing data, and a reporting start and end condition of sensing data; and send the first data packet to the terminal device.

In some embodiments, the transmission module 11 may be configured to: encrypt the first data packet, and send the first data packet to the terminal device.

In some embodiments, the obtaining module 12 may be configured to: obtain an encrypted data packet returned by the terminal device; decrypt the encrypted data packet to obtain a second data packet; decapsulate the second data packet; and obtain the sensing data according to the decapsulated second data packet.

In some embodiments, the sensing data reporting information includes the reporting frequency of sensing data and the maximum reporting quantity of sensing data. The transmission module 11 is further configured to send the reporting frequency of sensing data and the maximum reporting quantity of sensing data to a base station corresponding to the terminal device, so that the base station allocates and schedules resources according to the reporting frequency of sensing data and the maximum reporting quantity of sensing data.

In some embodiments, the sensing data request information includes the reporting frequency of sensing data, the apparatus 10 for obtaining sensing data may further include a detection module, which may be configured to: after sensing data is obtained according to the feedback information for the first time, detect, according to a time at which the terminal device first returns the feedback information, whether the terminal device returns the feedback information according to the reporting frequency of sensing data; and resend the sensing data request information to the terminal device if it is detected that the terminal device does not return the feedback information according to the reporting frequency of sensing data.

In some embodiments, the sensing data reporting information may include the sensing data type, and the sensing data type includes at least one of location information, speed information, acceleration information, temperature information, humidity information, wind speed information, and surrounding event information of the terminal device. The obtaining module 12 may be configured to obtain sensing data corresponding to the sensing data type according to the feedback information returned by the terminal device, where the sensing data includes at least one of the location information, the speed information, the acceleration information, the temperature information, the humidity information, the wind speed information, and the surrounding event information of the terminal device.

In some embodiments, the obtaining module 12 may further be configured to: obtain sensing capability indication information sent by the terminal device, where the sensing capability indication information is used for indicating whether the terminal device supports reporting of sensing data; and generate the sensing data request information and send a sensing data request to the terminal device if the sensing capability indication information indicates that the terminal device supports reporting of sensing data.

For the functions of each module in the apparatus 10 for obtaining sensing data in the embodiments of this disclosure, refer to the specific implementations in the foregoing method embodiments. Details are not described herein again.

The modules in the foregoing apparatus 10 for obtaining sensing data may be implemented entirely or partially by software, hardware, or a combination thereof. The foregoing modules may be built in or independent of a processor of a network device in a hardware form, or may be stored in a memory of the network device in a software form, so that the processor invokes and performs an operation corresponding to each of the foregoing modules.

For the apparatus 10 for obtaining sensing data provided in the embodiments of this disclosure, the transmission module 11 sends the sensing data request information to the terminal device, where the sensing data request information includes sensing data reporting information, and the sensing data request information is used for indicating the terminal device to report sensing data according to the sensing data reporting information. Next, the obtaining module 12 obtains the feedback information returned by the terminal device, where the feedback information is sent by the terminal device according to the sensing data reporting information. Sensing data is obtained according to the feedback information. In this way, a mobile network can obtain sensing data, to facilitate collaborative processing and utilization of sensing data by the mobile network.

FIG. 6 is a schematic structural diagram of an apparatus 20 for reporting sensing data according to an embodiment of this disclosure. As shown in FIG. 6, the apparatus 20 for reporting sensing data may include:
an obtaining module 21, configured to obtain sensing data request information sent by a network device, where the sensing data request information includes sensing data reporting information;
a determination module 22, configured to: determine target sensing data according to the sensing data reporting information, and generate feedback information according to the target sensing data, where the target sensing data is sensing data corresponding to the sensing data reporting information; and
a transmission module 23, configured to send the feedback information to the network device.

In some embodiments, the sensing data reporting information may include a sensing data type. The determination module 22 may be configured to: determine sensing data corresponding to the sensing data type as the target sensing data, where the target sensing data includes at least one of location data, speed data, acceleration data, temperature data, humidity data, wind speed data, and surrounding event data of the terminal device.

In some embodiments, the transmission module 23 is further configured to: determine sensing capability indication information according to sensing capability of the terminal device, where the sensing capability indication information is used for indicating whether the terminal device supports reporting of sensing data; and send the sensing capability indication information to the network device.

In some embodiments, the transmission module 23 may further be configured to: send the sensing capability indication information to the network device in a network registration procedure of the terminal device; or send the sensing capability indication information to the network device in a location update procedure of the terminal device; or send the sensing capability indication information to the network device in a session management procedure of the terminal device.

For the apparatus 20 for reporting sensing data provided in the embodiments of this disclosure, the obtaining module 21 obtains the sensing data request information sent by the network device, where the sensing data request information includes the sensing data reporting information. Next, the determination module 22 determines target sensing data according to the sensing data reporting information, and generates feedback information according to the target sensing data, where the target sensing data is sensing data corresponding to the sensing data reporting information. Then the transmission module 23 sends the feedback information to the network device, so that the network device obtains sensing data according to the feedback information. In this way, a mobile network obtains sensing data, to facilitate collaborative processing and utilization of sensing data by the mobile network.

The embodiments of this disclosure further provide a computer device, including a processor (processing circuitry) and a memory (non-transitory computer-readable storage medium). The memory stores a computer program. The processor implements, when executing the computer program, the steps of the foregoing methods in the embodiments of this disclosure.

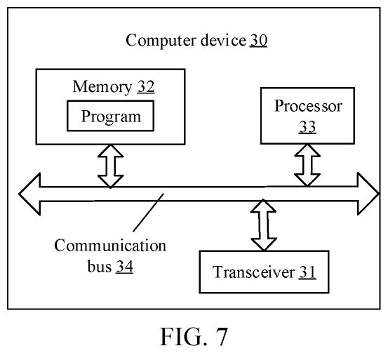

FIG. 7 is a schematic structural diagram of a computer device according to an embodiment of this disclosure. The computer device may be a network device in the mobile network shown in FIG. 1 (for example, a base station, or a network element), or may be the terminal shown in FIG. 1. As shown in FIG. 5, a computer device 30 may include a transceiver 31, a memory 32, a processor 33, and a communication bus 34. The transceiver 31, the memory 32, and the processor 33 communicate with each other through the communication bus 34. The processor 33 may control the transceiver 31 to communicate with another device, for example, may send information or data to another device, or receive information or data sent by another device. The transceiver 31 may include a transmitter and a receiver. The transceiver 31 may further include an antenna, and there may be one or more antennas. The memory 32 may be configured to store a software program and a module. The processor 33 executes the software program and the module stored in the memory 32, for example, a software program for corresponding operations in the foregoing method embodiments.

In some embodiments, the processor 33 may invoke the software program and the module stored in the memory 32 to perform the following operations: sending sensing data request information to a terminal device, where the sensing data request information includes sensing data reporting information, and the sensing data request information is used for indicating the terminal device to report sensing data according to the sensing data reporting information; obtaining feedback information returned by the terminal device, where the feedback information is sent by the terminal device according to the sensing data reporting information; and obtaining sensing data according to the feedback information.

In some embodiments, the processor 33 may invoke the software program and the module stored in the memory 32 to perform the following operations: obtaining sensing data request information sent by a network device, where the sensing data request information includes sensing data reporting information; determining target sensing data according to the sensing data reporting information, and generating feedback information according to the target sensing data, where the target sensing data is sensing data corresponding to the sensing data reporting information; and sending the feedback information to the network device.

The embodiments of this disclosure further provide a non-transitory computer-readable storage medium, configured to store a computer program. The computer-readable storage medium may be used in a computer device, and the computer program enables the computer device to perform corresponding procedures in the method for obtaining sensing data or the method for reporting sensing data in the embodiments of this disclosure. For brevity, details are not described herein again.

The embodiments of this disclosure further provide a computer program product. The computer program product includes a computer program or computer instructions. The computer program or the computer instructions are stored in a computer-readable storage medium. A processor of a computer device reads the computer program or the computer instructions from the computer-readable storage medium, and the processor executes the computer program or the computer instructions, to enable the computer device to perform corresponding procedures in the method for obtaining sensing data or the method for reporting sensing data in the embodiments of this disclosure. For brevity, details are not described herein again.

The embodiments of this disclosure further provide a computer program. The computer program includes a computer program or computer instructions. The computer program or the computer instructions are stored in a computer-readable storage medium. A processor of a computer device reads the computer program or the computer instructions from the computer-readable storage medium, and the processor executes the computer program or the computer instructions, to enable the computer device to perform corresponding procedures in the method for obtaining sensing data or the method for reporting sensing data in the embodiments of this disclosure. For brevity, details are not described herein again.

It is to be understood that the processor in the embodiments of this disclosure may be an integrated circuit chip having a signal processing capability. During implementation, the steps of the foregoing method embodiments may be completed through an integrated logic circuit of hardware or an instruction in the form of software in the processor. The foregoing processor may be a general purpose processor, a digital signal processor (DSP), an application-specific integrated circuit (ASIC), a field programmable gate array (FPGA), another programmable logic device, a discrete gate, a transistor logic device, or a discrete hardware component, may implement or execute methods, steps, and logical block diagrams disclosed in the embodiments of this disclosure. The general-purpose processor may be a microprocessor, or the processor may be any processor and the like. The steps of the methods disclosed with reference to the embodiments of this disclosure may be directly performed and completed by using a hardware decoding processor, or may be performed and completed by using a combination of hardware and software modules in the decoding processor. The software module may be stored in a storage medium that is mature in the art, such as a RAM, a flash memory, a ROM, a programmable ROM, an electrically erasable programmable memory, or a register. The storage medium is located in the memory, and the processor reads information in the memory and completes the steps in the foregoing methods in combination with hardware of the processor.

It may be understood that, the memory in the embodiments of this disclosure may be a volatile memory or a non-volatile memory, or may include both a volatile memory and a non-volatile memory. The non-volatile memory may be a read-only memory (ROM), a programmable ROM (PROM), an erasable PROM (EPROM), and an electronically EPROM (EEPROM), or a flash memory. The volatile memory may be a random access memory (RAM), which is used as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchronous DRAM (SLDRAM), and a direct rambus RAM (DR RAM). The memory of the systems and methods described herein is intended to include, but is not limited to, these and any other suitable types of memory.

It is to be understood that the foregoing memory is exemplary but not restrictive. For example, the memory in the embodiments of this disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a Direct Rambus RAM (DR RAM), and the like. That is, the memories in the embodiments of this disclosure are intended to include but not limited to these and any other suitable types of memories.

Those of ordinary skill in the art may realize that the units and algorithm steps of each example described in connection with the embodiments disclosed herein can be implemented by electronic hardware, or a combination of computer software and electronic hardware. Whether these functions are performed by hardware or software depends on particular applications and design constraints of the technical solutions. A person skilled in the art may use different methods to implement the described functions for each particular application, but it is not to be considered that the implementation goes beyond the scope of this disclosure.

Persons skilled in the art can clearly understand that for convenience and conciseness of description, for specific working processes of the foregoing described system, apparatus and unit, reference may be made to the corresponding processes in the foregoing method embodiments, and details are not described herein.

In the several embodiments provided in this disclosure, it is to be understood that the disclosed system, apparatus, and method may be implemented in other manners. For example, the described apparatus embodiment is merely an example. For example, the unit division is merely a logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the embodiments.

In addition, each functional unit in each embodiment of this disclosure may be integrated into one processing unit, or each unit may exist separately physically, or two or more units may be integrated into one unit.

In addition, each functional unit or module in each embodiment of this disclosure may be integrated into one processing unit or module, or each unit or module may exist separately physically, or two or more units may be integrated into one unit, or two or more modules may be integrated into one module.

When the function is implemented in the form of a software functional unit and sold or used as an independent product, the integrated unit may be stored in a computer-readable storage medium. Based on such an understanding, the technical solutions of this disclosure essentially, or the part contributing to the related technology, or some of the technical solutions may be implemented in the form of a software product. The computer software product is stored in a storage medium and includes several instructions for instructing a computer device (which may be a personal computer, a server, or the like) to perform all or some of the steps of the methods described in the embodiments of this disclosure. The foregoing storage medium includes any medium that can store program code, such as a USB flash drive, a removable hard disk, a ROM, a RAM, a magnetic disk, or an optical disc.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The use of “at least one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof.

The foregoing disclosure includes some exemplary embodiments of this disclosure which are not intended to limit the scope of this disclosure. Other embodiments shall also fall within the scope of this disclosure.

What is claimed is:

1. A method for obtaining sensing data, comprising:
transmitting, by a network function element to a terminal device, sensing data request information comprising parameters for sensing and reporting data by the terminal device, the sensing data request information indicating, to the terminal device, to report sensing data to the network function element according to the parameters; obtaining the sensing data returned by the terminal device, the sensing data being transmitted by the terminal device according to the parameters indicated in the sensing data request information; and
preprocessing, by the network function element, the sensing data and providing a result of the preprocessing to a server.

2. The method for obtaining sensing data according to claim 1, wherein the transmitting comprises:
encapsulating the sensing data request information into a first data packet, the parameters comprising at least one of a sensing data type, reporting frequency of the sensing data, a maximum reporting quantity of the sensing data, a reporting start time of the sensing data, a reporting end time of the sensing data, and a reporting start and end condition of the sensing data; and
transmitting the first data packet to the terminal device.

3. The method for obtaining sensing data according to claim 2, wherein
the parameters comprise the reporting frequency of the sensing data and the maximum reporting quantity of the sensing data, and
the method further comprises:
transmitting the reporting frequency of the sensing data and the maximum reporting quantity of the sensing data to a base station corresponding to the terminal device, so that the base station allocates and schedules resources according to the reporting frequency of the sensing data and the maximum reporting quantity of the sensing data.

4. The method for obtaining sensing data according to claim 2, wherein
the parameters comprise the reporting frequency of the sensing data, and
the method further comprises:
retransmitting the sensing data request information to the terminal device in response to a determination, according to a time at which the terminal device first returns the sensing data, that the terminal device has not returned the sensing data according to the reporting frequency of the sensing data after the sensing data is obtained for the first time.

5. The method for obtaining sensing data according to claim 2, wherein
the parameters comprise the sensing data type, including at least one of location information, speed information, acceleration information, temperature information, humidity information, wind speed information, and surrounding event information of the terminal device; and
the obtaining the sensing data comprises:
obtaining sensing data corresponding to the sensing data type returned by the terminal device, wherein the sensing data comprises the at least one of the location information, the speed information, the acceleration information, the temperature information, the humidity information, the wind speed information, and the surrounding event information.

6. The method for obtaining sensing data according to claim 1, wherein the obtaining the sensing data returned by the terminal device comprises:
obtaining an encrypted data packet returned by the terminal device;
decrypting the encrypted data packet to obtain a second data packet;
decapsulating the second data packet; and
obtaining the sensing data according to the decapsulated second data packet.

7. The method for obtaining sensing data according to claim 1, wherein the method further comprises:
obtaining sensing capability indication information transmitted by the terminal device, wherein the sensing capability indication information indicates whether the terminal device supports reporting of sensing data; and
generating the sensing data request information and transmitting the sensing data request information to the terminal device when the sensing capability indication information indicates that the terminal device supports the reporting of sensing data.

8. An apparatus for obtaining sensing data, comprising:
processing circuitry of a network function element configured to
transmit, to a terminal device, sensing data request information comprising parameters for sensing and reporting data by the terminal device, the sensing data request information indicating, to the terminal device, to report sensing data to the network function element according to the parameters;
obtain the sensing data returned by the terminal device, the sensing data being transmitted by the terminal device according to the parameters; and
preprocess the sensing data and provide a result of the preprocessing to a server.

9. The apparatus according to claim 8, wherein the processing circuitry is further configured to:
encapsulate the sensing data request information into a first data packet, the parameters comprising at least one of a sensing data type, reporting frequency of the sensing data, a maximum reporting quantity of the sensing data, a reporting start time of the sensing data, a reporting end time of the sensing data, and a reporting start and end condition of the sensing data; and
transmit the first data packet to the terminal device.

10. The apparatus according to claim 9, wherein
the parameters comprise the reporting frequency of the sensing data and the maximum reporting quantity of the sensing data, and
the processing circuitry is further configured to:
transmit the reporting frequency of the sensing data and the maximum reporting quantity of the sensing data to a base station corresponding to the terminal device, so that the base station allocates and schedules resources according to the reporting frequency of the sensing data and the maximum reporting quantity of the sensing data.

11. The apparatus according to claim 9, wherein
the parameters comprise the reporting frequency of the sensing data, and
the processing circuitry is further configured to:
retransmit the sensing data request information to the terminal device in response to a determination, according to a time at which the terminal device first returns the sensing data, that the terminal device has not returned the sensing data according to the reporting frequency of the sensing data after the sensing data is obtained for the first time.

12. The apparatus according to claim 9, wherein
the parameters comprise the sensing data type, including at least one of location information, speed information, acceleration information, temperature information, humidity information, wind speed information, and surrounding event information of the terminal device; and
the processing circuitry is further configured to:
obtain sensing data corresponding to the sensing data type returned by the terminal device, wherein the sensing data comprises the at least one of the location information, the speed information, the acceleration information, the temperature information, the humidity information, the wind speed information, and the surrounding event information.

13. The apparatus according to claim 8, wherein the processing circuitry is further configured to:
obtain an encrypted data packet returned by the terminal device;
decrypt the encrypted data packet to obtain a second data packet;
decapsulate the second data packet; and
obtain the sensing data according to the decapsulated second data packet.

14. The apparatus according to claim 8, wherein the processing circuitry is further configured to:
obtain sensing capability indication information transmitted by the terminal device, wherein the sensing capability indication information indicates whether the terminal device supports reporting of sensing data; and
generate the sensing data request information and transmitting the sensing data request information to the terminal device when the sensing capability indication information indicates that the terminal device supports the reporting of sensing data.

15. A non-transitory computer-readable storage medium storing computer-readable instructions thereon, which, when executed by processing circuitry of a network function element, cause the network function element to perform a method for obtaining sensing data, the method comprising:
transmitting, by the network function element to a terminal device, sensing data request information comprising parameters for sensing and reporting data by the terminal device, the sensing data request information indicating, to the terminal device, to report sensing data to the network function element according to the parameters;
obtaining the sensing data returned by the terminal device, the sensing data being transmitted by the terminal device according to the parameters indicated in the sensing data request information; and
preprocessing, by the network function element, the sensing data and providing a result of the preprocessing to a server.

16. The non-transitory computer-readable medium according to claim 15, wherein the transmitting comprises:
encapsulating the sensing data request information into a first data packet, the parameters comprising at least one of a sensing data type, reporting frequency of the sensing data, a maximum reporting quantity of the sensing data, a reporting start time of the sensing data, a reporting end time of the sensing data, and a reporting start and end condition of the sensing data; and
transmitting the first data packet to the terminal device.

17. The non-transitory computer-readable medium according to claim 16, wherein
the parameters comprise the reporting frequency of the sensing data and the maximum reporting quantity of the sensing data, and
the method further comprises:
transmitting the reporting frequency of the sensing data and the maximum reporting quantity of the sensing data to a base station corresponding to the terminal device, so that the base station allocates and schedules resources according to the reporting frequency of the sensing data and the maximum reporting quantity of the sensing data.

18. The non-transitory computer-readable medium according to claim 16, wherein
the parameters comprise the reporting frequency of the sensing data, and
the method further comprises:
retransmitting the sensing data request information to the terminal device in response to a determination, according to a time at which the terminal device first returns the sensing data, that the terminal device has not returned the sensing data according to the reporting frequency of the sensing data after the sensing data is obtained for the first time.

19. The non-transitory computer-readable medium according to claim 16, wherein
the parameters comprise the sensing data type, including at least one of location information, speed information, acceleration information, temperature information, humidity information, wind speed information, and surrounding event information of the terminal device; and
the obtaining the sensing data comprises:
obtaining sensing data corresponding to the sensing data type returned by the terminal device, wherein the sensing data comprises the at least one of the location information, the speed information, the acceleration information, the temperature information, the humidity information, the wind speed information, and the surrounding event information.

20. The non-transitory computer-readable medium according to claim 15, wherein the obtaining the sensing data returned by the terminal device comprises:
obtaining an encrypted data packet returned by the terminal device;
decrypting the encrypted data packet to obtain a second data packet;
decapsulating the second data packet; and
obtaining the sensing data according to the decapsulated second data packet.
